(19) United States
(12) Patent Application Publication
(10) Pub. No.: US 2020/0134639 A1
(43) Pub. Date: Apr. 30, 2020

(54) HOMOGENEOUS MODEL OF HETERGENEOUS PRODUCT LIFECYCLE DATA

(71) Applicant: Siemens Aktiengesellschaft, Munich (DE)

(72) Inventors: Arquimedes Martinez Canedo, Plainsboro, NJ (US); Livio Dalloro, Plainsboro, NJ (US); Georg Muenzel, Yardley, PA (US); Gustavo Arturo Quiros Araya, Princeton, NJ (US)

(21) Appl. No.: 16/493,452

(22) PCT Filed: Mar. 16, 2018
(86) PCT No.: PCT/US2018/022864

§ 371 Date: Sep. 12, 2019

Related U.S. Application Data
(60) Provisional application No. 62/472,176, filed on Mar. 16, 2017.

(51) Int. Cl. G06Q 30/02; G06N 7/00

(52) U.S. Cl. CPC G06Q 30/0201; G06N 7/005

(57) ABSTRACT

A method and system is disclosed for modeling product data related to lifecycle of a product, including an application program interface configured to connect with one or more data sources of different types via one or more computer based product management tools. A digital twin graph is constructed to include a plurality of graphical models of product data with related nodes inter-linked by edges via a linking algorithm. Models of the digital twin graph include an ontological model having nodes of ontological information related to the product data, an instance model having instance nodes related to the product data, and a probabilistic model having conditional probability distribution nodes from which causal and predictive reasoning information is generated.

### TECHNICAL FIELD

This application relates to product lifecycle data. More particularly, this application relates to graphical modeling of heterogeneous product lifecycle data.

### BACKGROUND

There can be a tremendous amount of data generated related to lifecycle of a product (or production system or process), from product conception, to its design, production, and service, until the moment it ceases to exist or to function. In addition to the large volume of the data, the variety and heterogeneous nature of the data continues to expand as more and more sources of data are introduced to keep up with technology and market demands. Product data management (PDM) systems have been developed to aggregate product data over its lifecycle. PDM systems provide built-in functionality to find data, to create variants of the data, label the data for classification, and store the data. Conventional PDM systems typically handle design and engineering data, but fail to account for operational data generated while products and systems are in use. Time-series database systems have been developed for storing operational data. While there is a vast landscape of product data stored in various repositories, the data is fragmented, and linking related data from such incongruous sources in an accurate and useful way with conventional tools is very difficult, if not impossible. Moreover, without a reliable model that can establish links, and extract conceptual knowledge from the linked data, there is currently no practical mechanism available to develop inferential information, which is essential for product lifetime management factors, such as failure diagnosis, prediction of failure, and degradation, among others.

### BRIEF DESCRIPTION OF THE DRAWINGS

Non-limiting and non-exhaustive embodiments of the present disclosure are described with reference to the following FIGURES, wherein like reference numerals refer to like elements throughout the drawings unless otherwise specified.

FIG. 1 illustrates an example of a temporally evolved digital twin graph (DTG) model constructed by interlinking an ontology model, an instance model, and a probabilistic graph model of heterogeneous product data.

FIG. 2 illustrates an example of interconnections between an ontology model and an instance model of a DTG according to one or more embodiments of the disclosure.

FIG. 3 illustrates an example of interconnecting data stores maintained by multiple product data tools in accordance with one or more embodiments of the disclosure.

FIG. 4 illustrates an example of a DTG supporting diagnostic analysis in accordance with one or more embodiments of the disclosure.

FIG. 5 illustrates an example of a DTG supporting control code deployment in accordance with one or more embodiments of the disclosure.

FIG. 6 illustrates an example of a DTG that provides simulation assisted prognostics based on data-driven and simulation-based models in accordance with one or more embodiments of the disclosure.

FIG. 7 illustrates an example of a DTG that provides simulation assisted prognostics based on data-driven and simulation-based models in accordance with one or more embodiments of the disclosure.

FIG. 8 illustrates an example of a computing environment within which embodiments of the present disclosure may be implemented.

### DETAILED DESCRIPTION

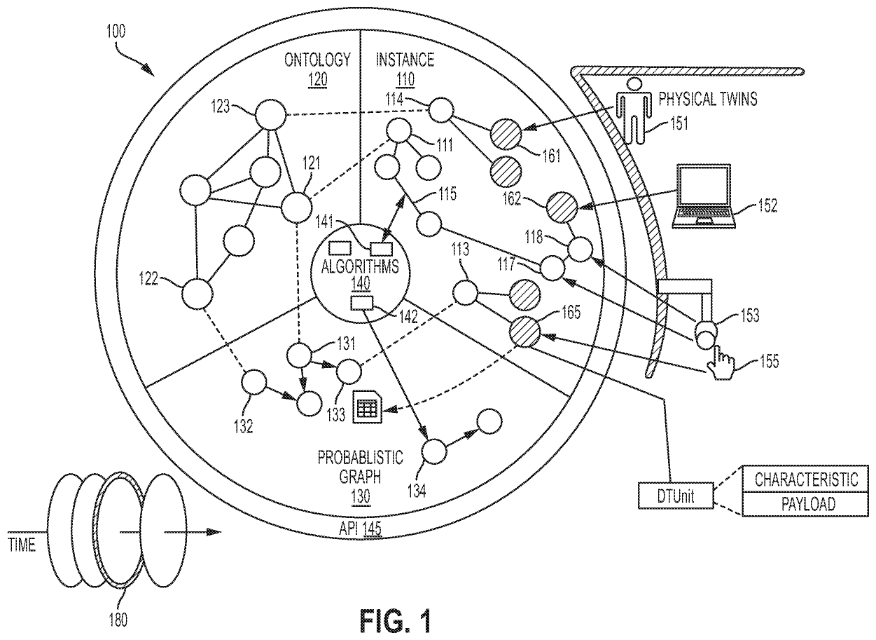

FIG. 1 illustrates an example of a temporally evolved digital twin graph (DTG) constructed by interlinking formalisms that include an ontology model, an instance model, and a probabilistic graph model of heterogeneous product data. Each model of the DTG may organize information and optimize for search, data streaming, inference, reasoning, and learning. Each model may be hosted centrally, distributed or on the edge. As shown, the DTG 100 may comprise instance model 110, ontology model 120, and probabilistic graph model 130, and may be extended to integrate new formalistic models. The instance model 110 includes instance nodes that represent physical world entities by a one-to-one mapping. The ontology model 120 includes nodes that define a set of concepts and categories, linked by their relationships. The probabilistic graph model 130 includes one or more nodes to implement a highly flexible mechanism for the integration of evidence from multiple sources. The probabilistic graph model 130 may enables probabilistic reasoning and causal exploration of the product data.

An API 145 may provide abstractions to simplify user access to internal structures of the DTG. The API 145 may provide a unified interface for interaction between the DTG 100 and various product data tools, such as tools implementing product data management (PDM). Algorithms 140 may execute searches of product data among the different models. For example, knowledge of the ontology model 120 may be extracted to initiate prognostic or diagnostic reasoning, and simulations where additional product data needs to be extracted to support probabilistic modeling. Algorithms 140 may also construct and maintain the various links between nodes in the DTG 100. Such links may be one-to-one, one-to-many, many-to-many relationships between the models, allowing model-specific algorithms to combine knowledge and insights globally. The DTG 100 represents a temporal evolution of the models 110, 120 and 130 as shown the time series 180 of DTG snapshots. The temporal evolution allows access to historical generation and expiration of nodes, edges and links, and may be maintained and tracked in a system memory. Storing the time series snapshots 180 permits the inference of cause-effect relationships in the product data over time, and the prediction of nodes or edges on the DTG 100 based on observation of historical DTG snapshots. In an embodiment, the maintenance may be implemented using blockchain. The DTG 100 may support data-driven and/or model driven construction of the models 110, 120, 130.

The DTG 100 may be defined as a graph G=(V, E), where V is a set of uniquely identifiable labeled nodes, and E is a set of uniquely identifiable labeled edges. Edges may be directed or symmetric (bi-directional). Each model 110, 120, 130 may provide a different modeling and functional capability to digital twin representation of the product data.

As shown in FIG. 1, the instance model 110 may include instance nodes inter-linked to one another, and some of which are related to a digital twin unit (DT Unit). Herein, the DT Unit is an entity of the DTG that updates very frequently to feed new information to the DTG. Each DT Unit may be linked to data related to a physical twin, and may be constructed to include a payload with pointers to the location of the data as stored in a data store (e.g., a database located in one or more local or remote servers). The DT Unit also includes characteristic feature information extracted from the payload by a distiller. Examples of physical twins that generate the data linked to the DT Units may include engineering data, tools, real world objects, and interactions thereof. The DTG 100 includes DT Unit 161 for engineering data generated by physical twin 151, DT Unit 162 related to engineering tool 152 (e.g., CAD data, control code, etc.) DT Unit 165 related to product in use data such as human interaction 155. Instance nodes 117 and 118 are related to a physical twin crane 153 and physical twin object 154.

Instance nodes may be interlinked with edges by an algorithm 140. For example, algorithm 141 may establish edge 115 upon recognition of a relationship between instance nodes. Algorithms 140 may also establish edge links between instance nodes and ontology nodes, as shown between nodes 114 and 123, and between nodes 111 and 121. Algorithms 140 may also construct the DTG by establishing links between ontology nodes 122, 121 and probabilistic graph nodes 132, 131. A further link is shown between nodes 133 and 113, linking the instance model 110 to the probabilistic graph model 130.

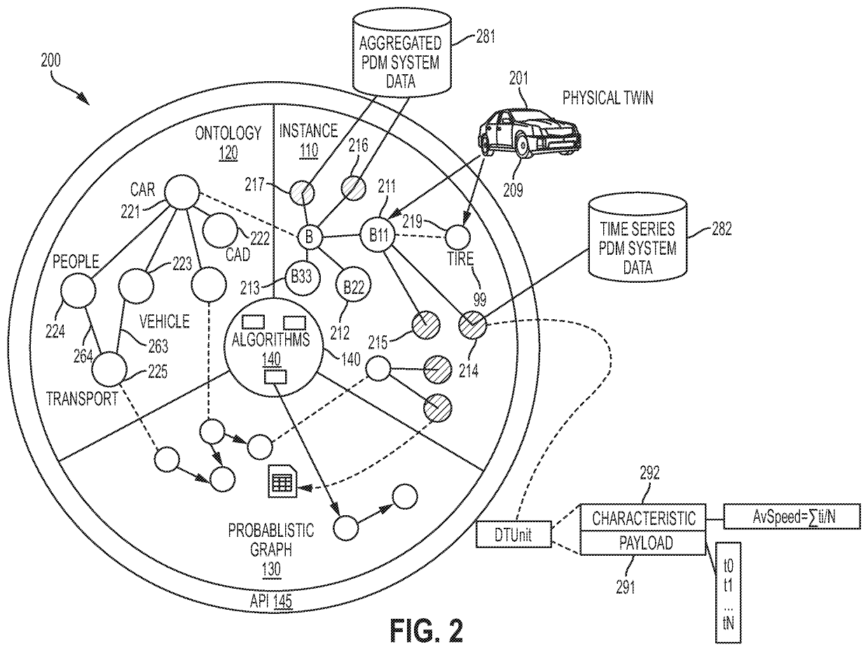

FIG. 2 illustrates an example of interconnections between an ontology model and an instance model of a DTG according to one or more embodiments of the disclosure. The DTG 200 may contain various inter-linked relationships within the instance model 110, and to the ontology model 120 and the probabilistic graph model 130, which allows access to a greater volume of digital information related to a physical twin, such as vehicle 201. In this example, product data relating to a model of a car, such as a Model B, is represented by the temporal DTG 200. One physical twin 201 is represented by digital twin instance node 211 labeled by its vehicle identification number (VIN) B11 in the instance model 110. An instance node 214 for Model B may be linked to various instance nodes of particular vehicles, such as nodes 211, 212, 213 for vehicles VIN B11, VIN B22, VIN B33 respectively. The ontology model 120 may represent the concepts generally relating to a car, such that each node represents a related concept, and each edge is the linking relationship. For example car node 221 may be linked to vehicle node 223 by edge ‘Is a’ 261. Vehicle node 223 may be linked to transport node 225 by an edge ‘provides’ 263. Transport node 225 may be linked to people node 224 by an edge ‘moves’ 264, and an edge ‘contains’ 265 may link car node 221 to people node 224. There may be several links between the instance model 110 and the ontology model 120, including link 266 between Model B node 212 and car node 221, which represents the notion that BMW 335 is a car. Each instance node may have links to DT Units, such as DT Unit 214 and DT Unit 215 related to product in use data generated by different sensors, such as an engine sensor for DT Unit 214 and an ABS sensor for DT Unit 215 related to the instance node 211. For each DT Unit, payload information 291 stored in a data store may be extracted by a distiller to produce the characteristic information 292 contained in the DT Unit. For example, an average speed characteristic of DT Unit 214 for the vehicle of instance node 211 may be distilled from a data store 282 of a time series based PLM tool (e.g., Siemens MindSphere) using a pointer stored the payload 291 of the DT Unit 214.

The model instance node 214 may represent a blueprint for all corresponding vehicles of that model. The model instance node 214 may be linked to DT Units tied to data stores, such as an aggregated PLM data tool. For example, CAD DTUnits 217 may contain characteristic information such as relevant geometric properties (e.g., eight, wheelbase distance), and payload information as a link to the actual CAD file stored in an aggregated type PLM tool database 281 (e.g., Siemens TeamCenter or NX). The SysML DT Units 216 may contain relevant architectural properties such as subsystem hierarchy. By linking design information, such as CAD related DT Units 217 and SysML DT Units 216 to the model instance node 214, a vast amount of product information corresponding to a particular vehicle may be accessed. For example, as defined in system modeling language SysML of DT Unit 216, the car model was designed to have four tires. Each vehicle instance node may include a link to instance nodes for the four tires currently installed on the vehicle. For example, the physical tire 209 has a corresponding instance node 219 identified by the tire model 99, and linked to the car instance node 211.

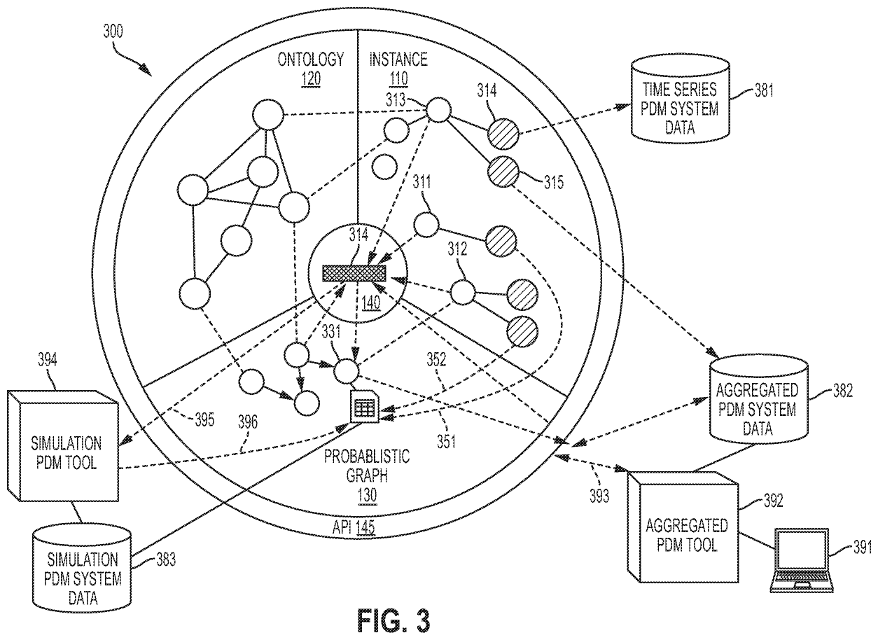

FIG. 3 illustrates an example of interconnecting data stores maintained by multiple product data tools in accordance with one or more embodiments of the disclosure. In this example, one or more DTG algorithms 140 may perform reasoning tasks among the inter-linked instance model 110, ontology model 120, and probabilistic graph model 130, triggering roundtrip requests related to a data inquiry. The DTG 300 includes a DT Unit 314 linked to database 381 of a time series based PLM tool, a DT Unit 315 linked to a database 382 of an aggregated based PLM tool, and a probabilistic graph model node 331 linked to simulation database 383. Using a PLM software tool stored at a server 392, a user may submit an inquiry 393 for a particular predictive report via GUI 391. The API 145 may route the inquiry to an appropriate algorithm 341 to the aggregated data store 382. The algorithm 341 may first search for all instance nodes in the instance model 110 that satisfy the query constraints to get a historical perspective. The algorithm 341 may link DT Unit 314 The algorithm 341 may find a probabilistic model 331 that relates to the inquiry, but lacks enough evidence because only two instances of evidence 351 and 352 were found to support the probabilistic graph model 331. The algorithm 341 may then trigger a roundtrip to a simulation tool 394 (e.g., Siemens SimCenter) to execute a simulation, and forward the results 395 as evidence in the probabilistic graph model 331. Algorithm 341 may also initiate a report that sends the result of the probabilistic graph model 331 to the user via the API 145, the product tool 392, and GUI 391.

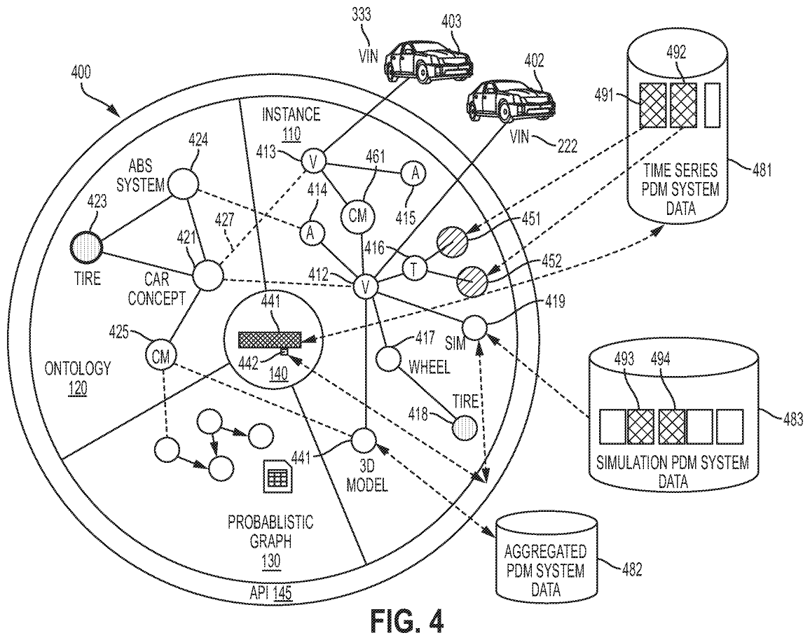

FIG. 4 illustrates an example of a DTG supporting diagnostic analysis in accordance with one or more embodiments of the disclosure. In this example, the DTG 400 is modeling an instance model 110, ontology model 201 and probabilistic graph model 130 related to data for a car experiencing a maintenance alarm. Physical twin 402 is a vehicle identified by VIN 222 and has an instance node 412. Upon detection of an alarm condition by an ABS sensor in the vehicle, a time series database 481 receives the information via a wireless telemetry signal. An algorithm 841 may be triggered to create a new DT Unit 452 for ABS sensor data as a pointer to the new data in database 481 and linked to telemetry instance 416. At a later time, the vehicle is brought to a service station, and a service technician may search the DTG 400 for diagnosing the trouble and making any required repairs. Using knowledge from the ontology model 120, an inquiry to the DTG 400 may trigger algorithm 842 to search and locate an existing 3D model, which has an instance node 411 linked to database 482 of an aggregated product data tool which highlights the ABS subsystem for the model of the vehicle. Algorithm 442 may further search and locate within the DTG 400 any log files related to an ABS alarm, which identifies the DT Units 451, 452 indicating there have been two such alarms. The DT Units 451, 452 have payloads that point to database modules 491 and 492 in database 481 of a time series based product data tool. The search of DTG 400 may also locate any simulations performed relating to the ABS subsystem for this model vehicle, such as instance node 419 for simulation data of the product simulation tool database 483. Within the simulation database 483, there are two relevant simulation animations 493, 494 which show a connection to deflated tires. From this information, the cause of the ABS alarm may be diagnosed as deflated tires based on the results of the DTG 400 data model application. The temporal DTG 400 may be updated with the new information by encoding the ontology node 423 for a tire with a new knowledge link 426 to ABS system node 424. Any future alarms in other vehicles, such as vehicle 403, may then use the new knowledge via a link between instance model 110 and ontology model 120, such as link 427 to instance node 413. Because a new link has been recorded in the ontology model 120 of the DTG 400, the information can be located with less steps for such alarms in vehicles of a similar model, related to car model instance node 461, having the benefit of the searching performed for vehicle 402.

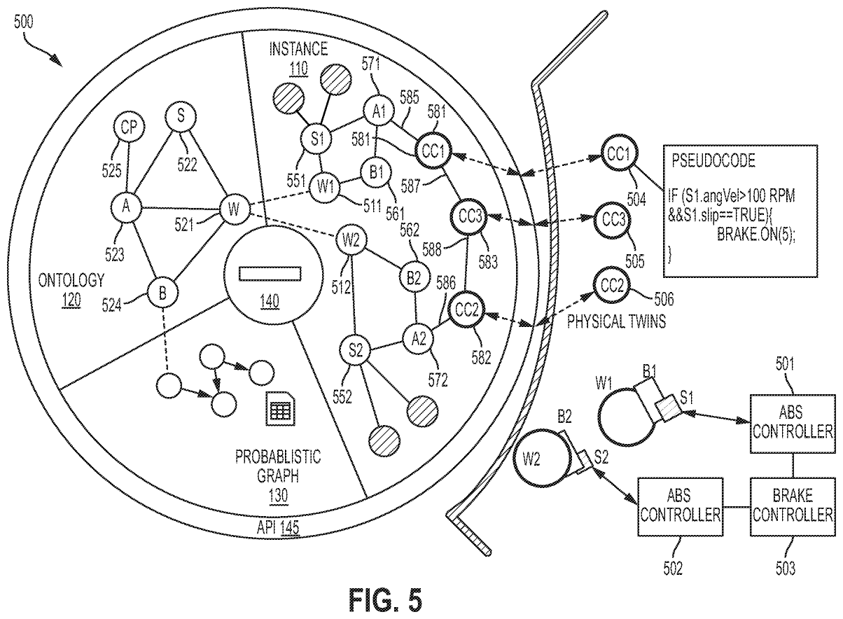

FIG. 5 illustrates an example of a DTG supporting control code deployment in accordance with one or more embodiments of the disclosure. In this example, a DTG 500 includes an instance model 110, ontology model 120 and probabilistic graph model 130 related to ABS controllers for a vehicle. The physical twins include wheels W1, W2, brakes B1, B2, sensors S1, S2, ABS controllers 501, 502, brake controller 503, and control logic codes 504, 505, 506. A control program maybe written assisted by the interconnected data for control architecture specified in the ontology model 120, and then deployed to the DTG 500. A wheel node 521 has links to an angular velocity (AV) sensor node 522 and a brake node 524. An ABS controller node 523 has links to the brake node 524, angular velocity sensor node 522 and control program node 525. Using the ontology knowledge of the configuration of these control elements, a design engineer, via a GUI, may instantiate the ontology by constructing corresponding instance nodes, such as node 511 for wheel W1, node 551 for AV sensor 51, node 561 for brake B1, node 571 for ABS controller A1. A GUI application may permit the design engineer to copy the instance nodes related to wheel W1 and paste as instance nodes for wheel W2 (i.e., nodes 512, 662, 562, 572). At this point, each of the physical twins has a corresponding digital twin node in the instance model 110. Pseudocode for control logic code 504 may be written during the engineering phase based on the knowledge of the ontology model 120. Using ATI 145, the instance node 581 for the control logic code 504 may be deployed to the DTG 500 with an edge 585 to instance node 571 for ABS controller A1. As an example for how the edge may be constructed, an application tool may prompt the design engineer as to which object is the control logic code written, and in reply, the node ID ‘A1’ may be entered by typing or by operating a displayed pull down menu, or the like. In a similar process, the control logic code 505 for the brake controller 503, and the control logic code 506 for the ABS controller 502 may be written and deployed to the instance model 120. The control logic code 506 may be copied from control logic code 504, deployed as instance node 582, and then linked to instance node 572 by edge 586. The top level control code 505 for brake controller 503 may be deployed to the DTG 500 as instance node 583 and linked by edges 587 and 588 to the instance nodes 581 and 582, mirroring the physical twin arrangement of controllers 501, 502 and 503. An embedded system such as an electronic control unit (ECU) may host subgraphs of the instance model 110 of the DTG 500 to provide context to a controller necessary to perform the control task. For example, an ECU for ABS controller 501 may host a subgraph of instance nodes 511, 551, 561, 571 and 581. An ECU for the brake controller 503 may host a subgraph of instance nodes 511, 561, 571, 581, 512, 562, 572, 582 and 583. Thus, as demonstrated by the DTG 500, control programs may be modeled in a DTG and deployed to controllers using a portion (i.e., subgraph) of the DTG.

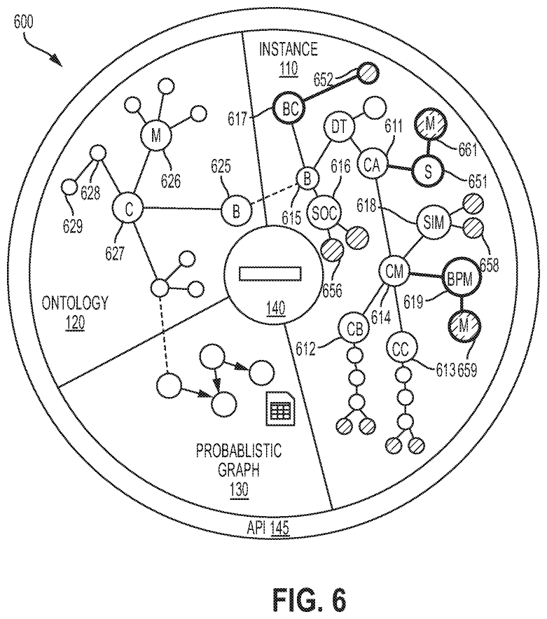

FIG. 6 illustrates an example of a DTG that provides simulation assisted prognostics based on data-driven and simulation-based models in accordance with one or more embodiments of the disclosure. In this example, DTG 600 applies simulations of the instance model 110 combined with sensor data to derive a prognostic analysis for a hybrid car. The instance model includes node 611 for car A, node 612 for car B and node 613 for car C, each linked to instance node 614 for the same car model. An instance node 615 for hybrid drivetrain battery is linked to ontology model 120 relating to battery knowledge via battery node 625. For example, the ontology model 120 may include a car node 627 linked to diagnostics node 628 and repair history node 629. A measurement node 626 may be linked to various types of relevant measurement nodes. During a scheduled maintenance service visit for car A, an algorithm 641 may retrieve state of charge (SOC) sensor data for cars A, B, C in order to estimate remaining life of the drivetrain battery in car A. Algorithm 641 may create a predictive battery model instance 619 by combining SOC sensor data 656 with battery simulation data 658 related to the car model, and linked to the instance node 614 for the car model. A DT Unit 659 for the battery model data may be parameterized according to the data for car AC. A diagnostic analysis for the hybrid car battery may indicate several options for a service plan based on the results. For example, new parameters 657 may be recommended for battery controllers, represented by instance node 617. A service schedule node 651 may add DT Unit 661 data for a maintenance order to return to a service center within a particular service interval.

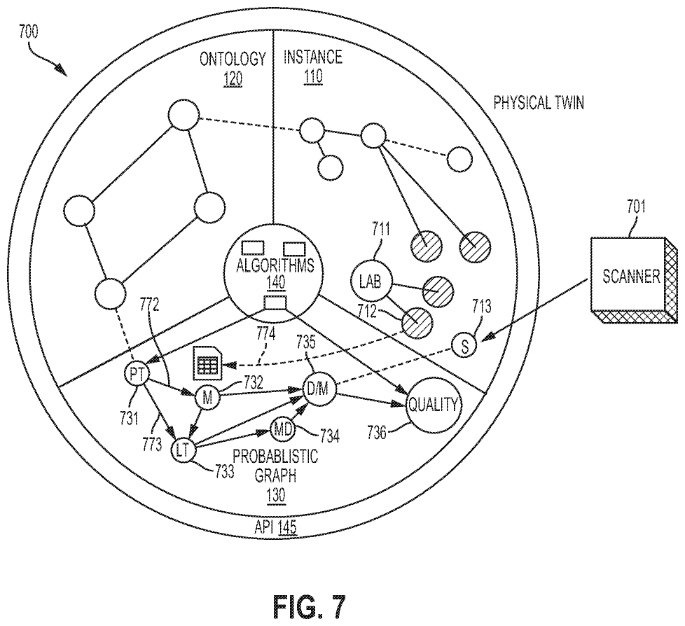

FIG. 7 illustrates an example of a DTG that provides simulation assisted prognostics based on data-driven and simulation-based models in accordance with one or more embodiments of the disclosure. In an embodiment, a DTG 700 implements a probabilistic graphical modeling of manufacturing processes to provide a probabilistic reasoning framework, such as variables implemented in a Bayesian network. For this example, reasoning patterns may be developed in a predictive top-down flow or in an evidential bottom-up flow using probabilistic reasoning tied to quality of a manufactured product of a 3D printer. An instance model 110 may include a lab node 711 and a scanner node 713 for a physical twin laser scanner 701. The probabilistic graph model 130 includes nodes that represent random variables, including printer type 731, material 732, layer thickness 733, manufacture duration 734, design/manufacture grade 735, and quality 736. Random variables may or may not be physical entities (e.g., Quality), and may provide a straightforward abstraction to any other nodes in the ontology model 120 or instance model 110. The probabilistic values associated with each node may define important properties or attributes of the world. Random variables to each node may be defined as follows:

Printer type={MB, ST, 3DW}

Material={PLA, ABS}

Layer thickness={500, 200, 100}

Manufacture duration={Short, Medium, Long}

Design/Manufacture grade={*, **, ***}

Quality={Pass, Fail}

Probabilistic nodes may be linked to instance nodes for receiving data. For example, a link exists between Design/Manufacture grade node 735 and scanner node 713, which relates to physical twin scanner 701 that scans the manufactured product for tolerances to design specifications. Directed edges between the nodes may represent dependence assertions on random variables. For example, edges 772, 773 represent dependency of Layer Thickness 733 on Material 732 and Printer Type 731 nodes. Conditional Probability Distributions (CPD) represent joint distributions. For example probability P values may be tabulated for the expression P(Material|Type of Printer) as follows:

TABLE 1

| | MB | ST | 3DW |
|---|---|---|---|
| PLA | 0.15 | 0.04 | 0.19 |
| ABS | 0.32 | 0.1 | 0.2 |

CPDs support a data-driven approach to model construction. Evidence that populates the CPD may include: no prior knowledge at all, expert knowledge, field data, simulation results, engineer at work or product in use time series, sensor data, and other sources. For example, evidence 774 for the CPD of Table 1 may be provided from production data DT Unit 712 linked to lab instance node 711 as shown in FIG. 7. In an embodiment, a causal reasoning or prediction (i.e., cause→effects) may be derived from the DTG 700 to determine a probability of a Pass quality when given the following variable values: MB printer type, PLA material, 500 micron layer thickness, which follows the probabilistic graph model 130 from top to bottom. In an embodiment, evidential reasoning or explanation (i.e., effects→reason) may be derived from the DTG 700 to determine a probability of the printer type being ST when given the following variable value: a product produced with “Failed” quality, which follows the probabilistic graph model 130 from bottom to top.

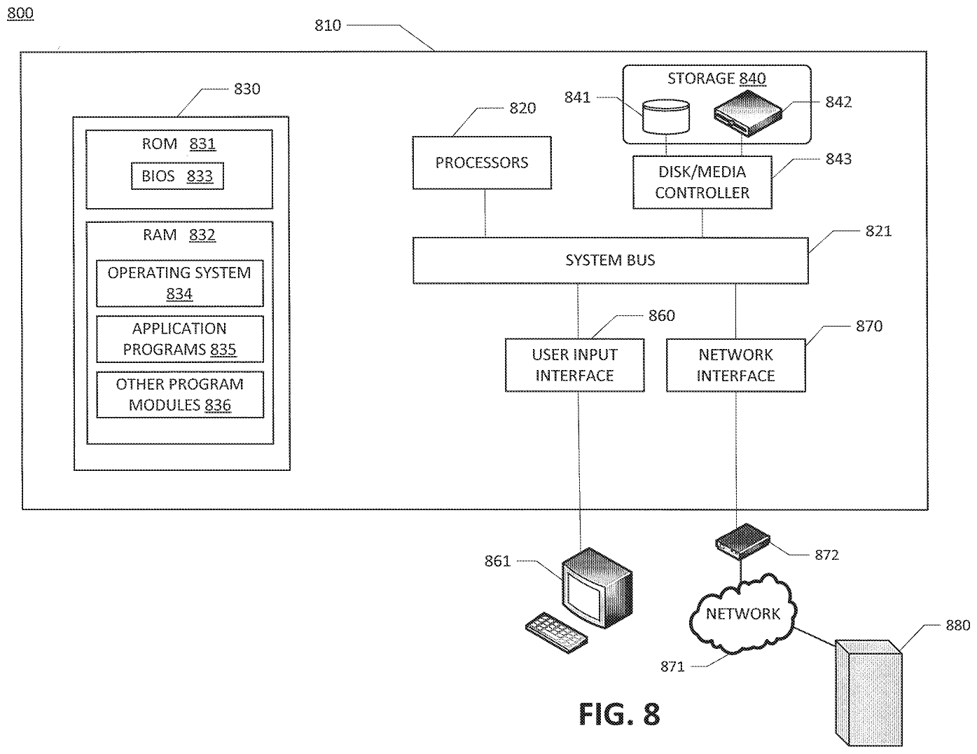

FIG. 8 illustrates an example of a computing environment within which embodiments of the present disclosure may be implemented. A computing environment 800 includes a computer system 810 that may include a communication mechanism such as a system bus 821 or other communication mechanism for communicating information within the computer system 810. The computer system 810 further includes one or more processors 820 coupled with the system bus 821 for processing the information.

The processors 820 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 820 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 821 may include at least one of a system bus, a memory bus, an address bus, or a message bus, and may permit exchange of information (e.g., data (including computer-executable code), signaling, etc.) between various components of the computer system 810. The system bus 821 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 8, the computer system 810 may also include a system memory 830 coupled to the system bus 821 for storing information and instructions to be executed by processors 820. The system memory 830 may include computer readable storage media in the form of volatile and/or nonvolatile memory, such as read only memory (ROM) 831 and/or random access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules that are immediately accessible to and/or presently being operated on by the processors 820. System memory 830 may additionally include, for example, operating system 834, application programs 835, and other program modules 836.

The operating system 834 may be loaded into the memory 830 and may provide an interface between other application software executing on the computer system 810 and hardware resources of the computer system 810. More specifically, the operating system 834 may include a set of computer-executable instructions for managing hardware resources of the computer system 810 and for providing common services to other application programs (e.g., managing memory allocation among various application programs). In certain example embodiments, the operating system 834 may control execution of one or more of the program modules depicted as being stored in the data storage 840. The operating system 834 may include any operating system now known or which may be developed in the future including, but not limited to, any server operating system, any mainframe operating system, or any other proprietary or non-proprietary operating system.

The computer system 810 may also include a disk/media controller 843 coupled to the system bus 821 to control one or more storage devices for storing information and instructions, such as a magnetic hard disk 841 and/or a removable media drive 842 (e.g., floppy disk drive, compact disc drive, tape drive, flash drive, and/or solid state drive). Storage devices 840 may be added to the computer system 810 using an appropriate device interface (e.g., a small computer system interface (SCSI), integrated device electronics (IDE), Universal Serial Bus (USB), or FireWire). Storage devices 841, 842 may be external to the computer system 810.

The computer system 810 may include a user input interface or GUI 861, which may comprise one or more input devices, such as a keyboard, touchscreen, tablet and/or a pointing device, for interacting with a computer user and providing information to the processors 820. A graphical user interface (GUI), as used herein, may include a display processor for generating one or more display images, and may enable user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as the magnetic hard disk 841 or the removable media drive 842. The magnetic hard disk 841 may contain one or more data stores and data files used by embodiments of the present invention. The data store may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, control data, sensor data, or any other data generated in accordance with the embodiments of the disclosure. Data store contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 800 may further include the computer system 810 operating in a networked environment using logical connections to one or more remote computers, such as remote computing device 880. The network interface 870 may enable communication, for example, with other remote devices 880 or systems and/or the storage devices 841, 842 via the network 871. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 880). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

It should be appreciated that the program modules, applications, computer-executable instructions, code, or the like depicted in FIG. 8 as being stored in the system memory 830 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device 880, and/or hosted on other computing device(s) accessible via one or more of the network(s) 871, may be provided to support functionality provided by the program modules, applications, or computer-executable code depicted in FIG. 8 and/or additional or alternate functionality. Further, functionality may be modularized differently such that processing described as being supported collectively by the collection of program modules depicted in FIG. 8 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 8 may be implemented, at least partially, in hardware and/or firmware across any number of devices.

It should further be appreciated that the computer system 810 may include alternate and/or additional hardware, software, or firmware components beyond those described or depicted without departing from the scope of the disclosure. More particularly, it should be appreciated that software, firmware, or hardware components depicted as forming part of the computer system 810 are merely illustrative and that some components may not be present or additional components may be provided in various embodiments. While various illustrative program modules have been depicted and described as software modules stored in system memory 830, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for modeling product data related to lifecycle of a product, comprising:
at least one server, comprising:
an application program interface configured to connect with one or more data sources of different types via one or more computer based product management tools; and
at least one processor configured to:
construct a digital twin graph comprising a plurality of graphical models of product data, each model having nodes and edges, each node having a uniquely identifiable label, each edge being directional or bi-directional, the models comprising:
an ontological model having nodes of ontological information related to the product data;
an instance model having instance nodes related to the product data, each instance node generated in response to receiving new product data; and
a probabilistic model having conditional probability distribution nodes from which causal and predictive reasoning information is generated; and
execute a linking algorithm to construct edges that inter-link data determined to be related between a pair of models.

2. The system of claim 1, wherein the instance model includes at least one digital twin unit comprising:
a payload with pointer values corresponding to a location of data stored in an external data store; and
a characteristic feature extracted from the payload.

3. The system of claim 2, further comprising a distiller algorithm configured to extract the characteristic feature.

4. The system of claim 2, wherein at least one digital twin unit includes product data related to one of engineering-at-work data, computer aided design (CAD) data, engineering tool code, or human-product interaction.

5. The system of claim 1, wherein the ontological information defines a set of concepts, categories, relationships, or a combination thereof, for the product data.

6. The system of claim 1, wherein the linking algorithm inter-links the instance model and the probability model by searching instance nodes and obtaining evidence for a conditional probability distribution node of the probability model.

7. The system of claim 1, wherein the processor is further configured to generate and record the plurality of models at intervals in a time series to form a temporal evolution of the plurality of models, the system further comprising a database for storing the temporal evolution.

8. The system of claim 1, wherein the processor is further configured to execute an algorithm that triggers a simulation by a first PDM system and sends the result to a second PDM system, and the transaction is recorded in the digital twin graph.

9. The system of claim 1, wherein the processor is further configured to execute an algorithm that deploys a pseudocode to a controller based on the topography of the digital twin graph.

10. The system of claim 1, wherein the processor is further configured to execute algorithms that combine sensor data with simulation data to construct a diagnostic model with parameterized data, generate new control parameters, and generate a service interval schedule based on the diagnostic model.

11. A method for modeling product data related to lifecycle of a product, comprising:
using an application program interface to connect with one or more data sources of different types via one or more computer based product management tools;
constructing a digital twin graph comprising a plurality of graphical models of product data, each model having nodes and edges, each node having a uniquely identifiable label, each edge being directional or bi-directional, the models comprising:
an ontological model having nodes of ontological information related to the product data;
an instance model having instance nodes related to the product data, each instance node generated in response to receiving new product data; and
a probabilistic model having conditional probability distribution nodes from which causal and predictive reasoning information is generated; and
executing a linking algorithm to construct edges that inter-link data determined to be related between a pair of models.

12. The method of claim 11, wherein the instance model includes at least one digital twin unit comprising:
a payload with pointer values corresponding to a location of data stored in an external data store; and
a characteristic feature extracted from the payload.

13. The method of claim 12, further comprising executing a distiller algorithm to extract the characteristic feature.

14. The method of claim 12, wherein at least one digital twin unit includes product data related to one of engineering-at-work data, computer aided design (CAD) data, engineering tool code, or human-product interaction.

15. The method of claim 11, wherein the ontological information defines a set of concepts, categories, relationships, or a combination thereof, for the product data.

16. The method of claim 11, wherein the linking algorithm inter-links the instance model and the probability model by searching instance nodes and obtaining evidence for a conditional probability distribution node of the probability model.

17. The method of claim 11, further comprising:
generating and recording the plurality of models at intervals in a time series to form a temporal evolution of the plurality of models, and storing the temporal evolution in a database.

18. The method of claim 11, further comprising:
executing an algorithm that triggers a simulation by a first PDM system and sends the result to a second PDM system, and
recording the transaction in the digital twin graph.

19. The method of claim 11, further comprising executing an algorithm that deploys a pseudocode to a controller based on the topography of the digital twin graph.

20. The method of claim 11, further comprising executing algorithms that combine sensor data with simulation data to construct a diagnostic model with parameterized data, generate new control parameters, and generate a service interval schedule based on the diagnostic model.
